(19) United States
(12) Patent Application Publication
(10) Pub. No.: US 2017/0185662 A1
(43) Pub. Date: Jun. 29, 2017

(54) MEANS TO PROCESS HIERARCHICAL JSON DATA FOR USE IN A FLAT STRUCTURE DATA SYSTEM

(71) Applicant: INTERNATIONAL BUSINESS MACHINES CORPORATION, Armonk, NY (US)

(72) Inventors: DI HUANG, PRINCETON JUNCTION, NJ (US); XIN JIN, WEST WINDSOR, NJ (US); JEFF J. LI, PARKLAND, FL (US); YONG LI, NEWTON, MA (US)

(73) Assignee: International Business Machines Corporation, Armonk, NY (US)

(21) Appl. No.: 15/057,194

(22) Filed: Mar. 1, 2016

Related U.S. Application Data
(63) Continuation of application No. 14/982,264, filed on Dec. 29, 2015, now abandoned.

(51) Int. Cl. G06F 17/30

(52) U.S. Cl. CPC G06F 17/30569; G06F 17/30318; G06F 17/30292

(57) ABSTRACT

A data system can include a JavaScript Object Notation (JSON) data source, a cluster computing system, and a hierarchical JSON handler. The schema of the JSON data source can include a hierarchically-structured element having a nested array. The cluster computing system can store datasets across multiple nodes for parallel manipulation. The datasets can have a flat structure and can be queried using a Structured Query Language (SQL). The cluster computing system can lack the ability to directly import the hierarchically-structured element of the JSON data source into a dataset. The hierarchical JSON handler can be configured to extract and flatten the hierarchically-structured element of the JSON data source and import the extracted and flattened JSON data into one or more target datasets of the cluster computing system. The cluster computing system can then able to perform operations upon the target datasets.

### CROSS-REFERENCE TO RELATED APPLICATIONS

This application is a Continuation of U.S. patent application Ser. No. 14/982,264, filed 29 Dec. 2015 (pending), which is incorporated herein in its entirety.

### BACKGROUND

The present invention relates to the field of data processing and, more particularly, to a means to process hierarchical JavaScript Object Notation (JSON) data for use in a flat structure data system.

JavaScript Object Notation (JSON) is a popular data format used in cloud and enterprise applications. JSON data is written as name/value pairs. The structure of JSON data becomes more complex when a value is an array and/or object. It is typical for JSON data to have a hierarchical structure (i.e., nested arrays or objects).

APACHE SPARK is a cluster computing framework that is widely used for fast data analytics. APACHE SPARK is capable of using data from JSON sources. However, the support provided by its current toolsets (e.g., DataFrame, SparkSQL) is more suited to flat JSON data and not the hierarchical structures. Current approaches for using complex JSON data require the developer to generate complicated queries using the Structured Query Language (SQL), which are often beyond the capabilities of the average developer.

### BRIEF SUMMARY

One aspect of the present invention can include a data system that includes a JavaScript Object Notation (JSON) data source, a cluster computing system, and a hierarchical JSON handler. The schema of the JSON data source can include a set of hierarchically-structured elements having nested arrays. The cluster computing system can store datasets across multiple nodes for parallel manipulation. The datasets can have flat structures and can be queried using a Structured Query Language (SQL). The cluster computing system can lack the ability to directly import the hierarchically-structured elements of the JSON data source into a dataset. The hierarchical JSON handler can be configured to extract and flatten the hierarchically-structured elements of the JSON data source and import the extracted and flattened JSON data into one or more target datasets of the cluster computing system. The cluster computing system can then able to perform operations upon the target datasets.

Another aspect of the present invention can include a method that begins with receipt of a set of user-selected hierarchically-structured data elements for extraction from a JavaScript Object Notation (JSON) data source via a graphical user interface (GUI). The hierarchically-structured data elements can include nested arrays. The JSON data source can be processed using a hierarchical JSON handler engine to produce one or multiple flat output structures for the hierarchically-structured schema elements. Each record in a flat output structure can correspond to the data of one or many selected hierarchically-structured schema elements Records from the flat output structures can be copied to user-specified flat datasets for use in a cluster computing system. The cluster computing system can lack the ability to directly import the hierarchically-structured data element of the JSON data source into a flat dataset.

Yet another aspect of the present invention can include a computer program product that includes a computer readable storage medium having embedded computer usable program code. The computer usable program code can be configured to receive a set of user-selected hierarchically-structured data elements for extraction from a JavaScript Object Notation (JSON) data source via a graphical user interface (GUI). The hierarchically-structured data elements can include nested arrays. The computer usable program code can be configured to process the JSON data source to produce flat output structures for the hierarchically-structured schema elements. Each record in the flat output structure can correspond to the data of one or many hierarchically-structured schema elements. The computer usable program code can be configured to copy records from the flat output structures to user-specified flat datasets for use in a cluster computing system. The cluster computing system can lack the ability to directly import the hierarchically-structured data element of the JSON data source into a flat dataset.

### BRIEF DESCRIPTION OF THE SEVERAL VIEWS OF THE DRAWINGS

FIG. 1 is a schematic diagram illustrating a system for handling hierarchically-structured data from a JSON source in a cluster computing system in accordance with embodiments of the inventive arrangements disclosed herein.

FIG. 2 is a flowchart of a method describing the general operation of the hierarchical JSON handler in accordance with embodiments of the inventive arrangements disclosed herein.

FIG. 3 illustrates an example user interface for the hierarchical JSON handler in accordance with embodiments of the inventive arrangements disclosed herein.

### DETAILED DESCRIPTION

The present invention discloses a solution for handling complex JSON data in APACHE SPARK. Such a solution can present the complex schema of a user-selected JSON source as a tree structure within a graphical user interface (GUI). When a user selects a set of hierarchically-structured data elements for use in APACHE SPARK, a hierarchical JSON handler can extract and transform the hierarchically-structured data into one or many flat output structures. Records of the flat output structures can then be copied into target datasets for use in APACHE SPARK.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

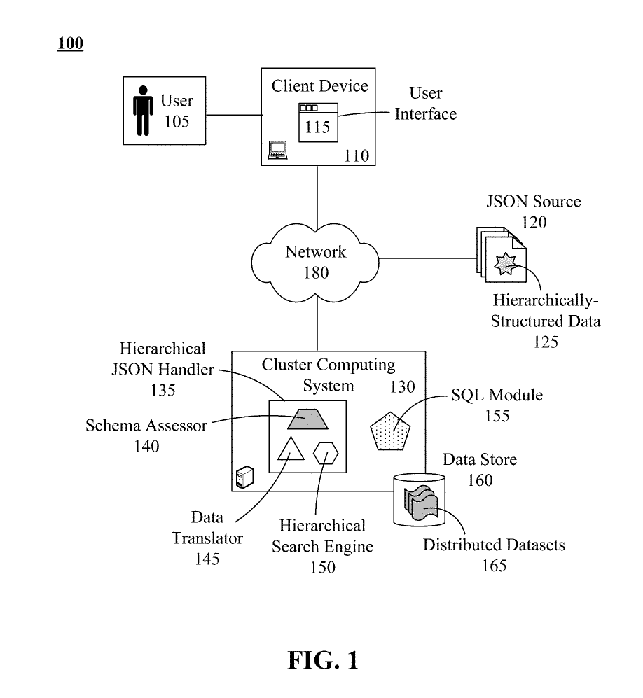

FIG. 1 is a schematic diagram illustrating a system 100 for handling hierarchically-structured data 125 from a JSON source 120 in a cluster computing system 130 in accordance with embodiments of the inventive arrangements disclosed herein. In system 100, a user 105 can process hierarchically-structured data 125 from a JavaScript Object Notation (JSON) source 120 using a hierarchical JSON handler 135 for use in a cluster computing system 130.

The user 105 can interact with the hierarchical JSON handler 135 via a user interface 115 running on a client device 110. The client device 110 can represent a variety of computing devices capable of supporting operation of the user interface 115 and communicating with the hierarchical JSON handler 135 and/or cluster computing system 130. The user interface 115 can employ known conventions and techniques for presenting data and accepting input commensurate with the capabilities of the client device 110.

Via the user interface 115, the user 105 can select a JSON source 120 to be used by the cluster computing system 130. The JSON source 120 can be a collection of data conforming to the JSON format. As is well known in the Art, it can be common for a JSON source 120 to include one or more elements of hierarchically-structured data 125, which is the circumstance of particular concern to the present disclosure.

To elaborate, JSON data can be expressed as name/value pairs. In simple data structures, the relationship between the name and the value of a pair can be one-to-one. Using contact information as an example, a simple name/value pair of such data can be ‘name: Mary Jones’.

The JSON format can also allow for more complex structuring of data having a one-to-many relationship between the name and value through the use of arrays and objects. Continuing with the theme of contact information, people can often have multiple phone numbers like a home number, a cell number, and a work number. In such an example, these multiple phone numbers can be expressed as an array named ‘Phone Number’ having objects, set of name/value pairs, that capture the phone number and its type, as shown below.

```
“phoneNumber”: [
  { “type”: “home”,
      “number”: “123 555-1147”
  },
  { “type”: “cell”,
      “number”: “123 555-6547”
  }]
```

This type of data structure can be easily represented as a tree with each different type of phone number creating its own branch of data. Many data processing tools and/or techniques, such as structured query language (SQL), cannot directly manipulate data expressed in a non-flat or tree structure. Thus, in order to utilize the hierarchically-structured data 125 of the JSON source 120, the hierarchically-structured data 125 can be flattened by the hierarchical JSON handler 135 for use in the cluster computing system 130.

It should be noted that the structuring of data within a JSON source 120 is determined by its schema. The schema can be defined by the requirements of the specific system as well as the proficiency of the authoring developer. While not every JSON source 120 may contain complex data structures, support of such structures can imply their use, and, therefore, the need to handle complex data structures by data processing systems like the cluster computing system 130.

The cluster computing system 130 can represent the hardware and/or software necessary to perform parallel data manipulation operations on distributed datasets 165. APACHE SPARK can be an example of a cluster computing system 130. A distributed dataset 165 can represent a logical collection of data that is distributed across multiple nodes of the cluster computing system 130. The distributed datasets 165 can be flat structures, meaning that each record or row contains multiple data fields of simple data types such as varchar, int, double, float, decimal, and boolean.).

The cluster computing system 130 can include the hierarchical JSON handler 135, a SQL module 155, and a data store 160 for storing the distributed datasets 165. The cluster computing system 130 can include additional components to support other functionality without departing from the spirit of the present disclosure.

The SQL module 155 can be the component of the cluster computing system 130 configured to perform operations upon the distributed datasets 165 using SQL, as is known in the Art. The SQL module 155 can be similar to the SPARK SQL component utilized by APACHE SPARK.

The hierarchical JSON handler 135 can represent a component configured to transform the hierarchically-structured data 125 of the JSON source 120 into one or multiple flat structures for use in the distributed datasets 165 of the cluster computing system 130. To accomplish this function, the hierarchical JSON handler 135 can include a schema assessor 140, a data translator 145, and a hierarchical search engine 150.

The schema assessor 140 can analyze the user-selected JSON source 120 to determine its schema. It can be assumed that the schema of the JSON source 120 is previously unknown or unavailable to the hierarchical JSON handler 135.

In another contemplated embodiment, the hierarchical JSON handler 135 can be configured to request the schema of the JSON source 120 from its parent data system. If the parent data system is able to provide the schema, use of the schema assessor 140 can be circumvented.

The schema assessor 140 can present the determined schema as a tree to the user 105 in the user interface 115. The user 105 can use the presented schema to select the elements to be used in the cluster computing system 130.

The data translator 145 can represent the component of the hierarchical JSON handler 135 that uses the user's 105 schema selections to create search paths for the hierarchical search engine 150. The hierarchical search engine 150 can be a search engine configured to retrieve data elements from hierarchically-structured data 125. The results returned by the hierarchical search engine 150 can include their hierarchical structure starting with their root object.

The data translator 145 can transform the hierarchical results of the hierarchical search engine 150 into a flat structure. Additionally, the data translator 145 can perform data shaping operations (e.g., sorting, filtering, formatting, etc.) on the flattened results as selected by the user 105. The hierarchical JSON handler 135 can then copy the flattened results to the distributed datasets 165 specified by the user 105.

In another embodiment, the hierarchical JSON handler 135 can operate on a server (not shown) remote from the cluster computing system 130. In such an embodiment, the hierarchical JSON handler 135 and cluster computing system 130 can be configured to interact over the network 180.

As used herein, presented data store 160 can be a physical or virtual storage space configured to store digital information. Data store 160 can be physically implemented within any type of hardware including, but not limited to, a magnetic disk, an optical disk, a semiconductor memory, a digitally encoded plastic memory, a holographic memory, or any other recording medium. Data store 160 can be a stand-alone storage unit as well as a storage unit formed from a plurality of physical devices. Additionally, information can be stored within data store 160 in a variety of manners. For example, information can be stored within a database structure or can be stored within one or more files of a file storage system, where each file may or may not be indexed for information searching purposes. Further, data store 160 can utilize one or more encryption mechanisms to protect stored information from unauthorized access.

Network 180 can include any hardware/software/and firmware necessary to convey data encoded within carrier waves. Data can be contained within analog or digital signals and conveyed though data or voice channels. Network 180 can include local components and data pathways necessary for communications to be exchanged among computing device components and between integrated device components and peripheral devices. Network 180 can also include network equipment, such as routers, data lines, hubs, and intermediary servers which together form a data network, such as the Internet. Network 180 can also include circuit-based communication components and mobile communication components, such as telephony switches, modems, cellular communication towers, and the like. Network 180 can include line based and/or wireless communication pathways.

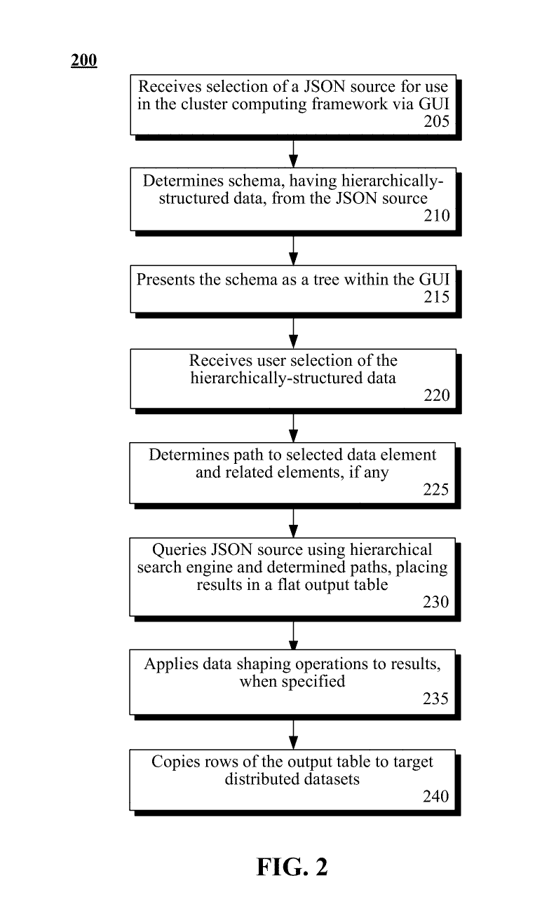

FIG. 2 is a flowchart of a method 200 describing the general operation of the hierarchical JSON handler in accordance with embodiments of the inventive arrangements disclosed herein. Method 200 can be performed within the context of system 100.

Method 200 can begin in step 205 where the hierarchical JSON handler can selection of a JSON source for use in the cluster computing system via the GUI. The schema of the JSON source, which has hierarchically-structured data, can be determined in step 210.

In step 215, the determined schema can be presented within the GUI as a tree structure, illustrating the hierarchically-structured data. User-selection of the hierarchically-structured data can be received in step 220. In step 225, the paths to the selected data elements and any necessary related elements can be determined. Necessary related elements can represent child data of the selected data element.

The JSON source can be queried using the hierarchical search engine and the determined paths in step 230. The results of the query can be placed in flat output tables. The flat output tables can be temporary data structures.

In step 235, data shaping operations can be applied to the results in the flat output tables, when specified by the user. The rows of the output tables can then be copied to the user-specified target distributed datasets in step 240.

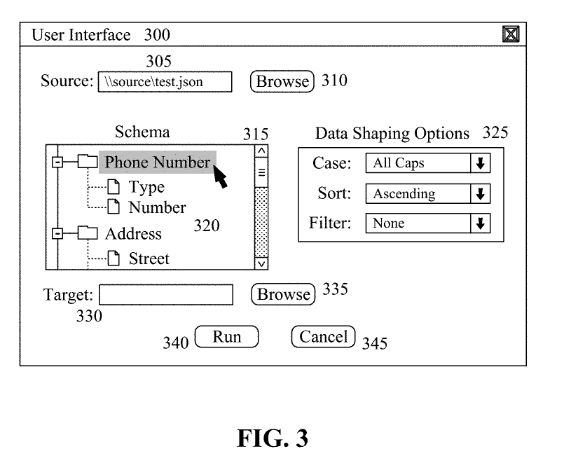

FIG. 3 illustrates an example user interface 300 for the hierarchical JSON handler in accordance with embodiments of the inventive arrangements disclosed herein. The example user interface 300 can be utilized within the context of system 100 and/or method 200.

User interface 300 can include mechanisms for presenting and accepting data. These mechanisms can include source and target selection 305 and 330 and presentation of the source schema 315 and data shaping options 325. In this example, the JSON source and target dataset selection mechanisms can be comprised of a text field 305 and 330 and a browse button 310 and 335. The user can manually enter the text defining the path of the source or target in the text field 305. Alternately, the user can utilize the select button 310 and 335 to visually navigate to the desired source or target; the selection can then be displayed in the text field 305 and 330.

An area of the user interface 300 can be configured for schema 315 presentation. Since hierarchically-structured data is being presented, the schema display 315 can accommodate presentation as an expandable/collapsible tree structure 320. The user can select data elements (i.e., node) of the tree structure 320 for extraction into the cluster computing system.

The user interface 300 can also include a section where the user can select data shaping operations 325 that are to be performed on the extracted data. The mechanisms to achieve this can vary depending upon the specific implementation of the user interface 300. In this example, each data shaping option 325 can be presented as a pull-down menu of user-selectable items.

The user can select the run button 340 to extract and process the selected data element of the JSON source into the target datasets. The cancel button 345 can be used to discard the user's selections and close the user interface 300.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
receiving a user-selected hierarchically-structured data element for extraction from a JavaScript Object Notation (JSON) data source via a graphical user interface (GUI), wherein the hierarchically-structured data element comprises at least one nested array;
processing the JSON data source using a hierarchical JSON handler engine to produce a flat output structure for the hierarchically-structured schema element, wherein each record in the flat output structure corresponds to data of an array element; and
copying records from the flat output structure to a plurality of user-specified flat datasets for use in a cluster computing system, wherein the cluster computing system lacks an ability to directly import the hierarchically-structured data element of the JSON data source into a flat dataset.
